(19) United States
(12) Patent Application Publication
(10) Pub. No.: US 2003/0012008 A1
(43) Pub. Date: Jan. 16, 2003

(54) Light guide plate and backlight module capable of converting a light source wavelength

(75) Inventors: Sung-Shui Chang, Hsinchu (TW); Kai Ming Wu, Hsinchu (TW)

Correspondence Address: Eugene Mar, BACON & THOMAS, PLLC, Fourth Floor, 625 Slaters Lane, Alexandria, VA, 22314-1176, US

(73) Assignee: AU Optronics Corp., HsinChu City (TW)

(21) Appl. No.: 10/191,316

(22) Filed: Jul. 10, 2002

(30) Foreign Application Priority Data
Jul. 10, 2001 (TW) 90116902

(51) Int. Cl. G01D 11/28

(52) U.S. Cl. 362/27; 362/26; 362/31; 362/84

(57) ABSTRACT

A light guide plate for flat panel display devices is used with at least one light source, being characterized in that the light guide plate comprises at least one fluorescent composition coated on a side adjacent to the light source to receive incident light and convert the incident light into white light.

### BACKGROUND OF THE INVENTION

1. Field of the Invention

The present invention relates to a light guide plate, and more particularly, to a light guide plate for flat panel display devices.

2. Description of Related Art

Liquid crystal display devices generally use a cold cathode fluorescent lamp or a white-light emitting diode that emits a visible white light as a light source. However, white light supply sources, e.g., a white-light emitting diode, are limited. Also, the cost for white light sources is high. Due to the limited supply source, f the manufacturing costs and assembly costs of flat panel display devices are difficult to reduce. On the other hand, flat panel display devices usually adopt white light sources other than colored light sources. This narrows the application and selection for the light sources.

Therefore, it is desirable to provide an improved light guide plate and backlight module capable of converting a light source wavelength to mitigate and/or obviate the aforementioned problems.

### SUMMARY OF THE INVENTION

The primary object of the present invention is to provide a light guide plate or a flat panel display device that can use a light source emitting a visible non-white light by converting the visible non-white light into a visible white light for illumination.

The secondary object of the present invention is to provide a light guide plate that can use a blue-light emitting diode or an ultraviolet-light emitting diode or the like to serve as the light source for flat panel displays.

Another object of the present invention is to provide a means that can significantly improve the uniformity problem caused by conventional techniques.

The light guide plate of the present invention for flat panel display devices used with at least one light source, comprising: a flat light guide substrate and at least one fluorescent composition on one side of said light guide substrate adjacent to the light source to receive incident light and convert the incident light into a white light. The flat light guide substrate can be any conventional substrate that can guide the incident light into the substrate homogeneously.

According to the present invention a backlight module comprises at least one light source; a light guide plate having a fluorescent composition formed on a side adjacent to the light source; and a reflecting plate adjacent to the light source for reflecting a light from the light source to the side of the light guide plate on which the light is incident; wherein the fluorescent composition converts the incident light into a white light.

The flat panel display device of the present invention comprising a display panel and a backlight module, said backlight module including: t least one light source; a light guide plate having a fluorescent composition formed on a side adjacent to the light source; and a reflecting plate adjacent to the light source for reflecting a light from the light source to the side of the light guide plate on which the light is incident; wherein the fluorescent composition converts the incident light into white light.

To illustrate the present invention, an exemplary embodiment of a light guide plate for flat panel displays will now be described with reference to the accompanying drawing.

### BRIEF DESCRIPTION OF THE DRAWING

FIG. 1 is a schematic view of a preferred embodiment of the present invention.

### DETAILED DESCRIPTION OF THE PREFERRED EMBODIMENT

The fluorescent composition coated on the incident side of the light guide substrate for flat panel display devices according to the present invention is capable of converting incident light into white light. Preferably, the incident light having a wavelength in the blue light region or the ultraviolet light region, and is then converted into white light. The shape of the light guide substrate suitable for the present invention is not limited, and preferably, the light guide substrate is wedge shaped or square shaped. The light source of the backlight module suitable for the present invention is not limited, and preferably, is an ultraviolet-light emitting diode or a blue-light emitting diode. The backlight module for flat panel display devices according to the present invention may further include a prism layer or a light diffusion layer to increase the efficiency thereof.

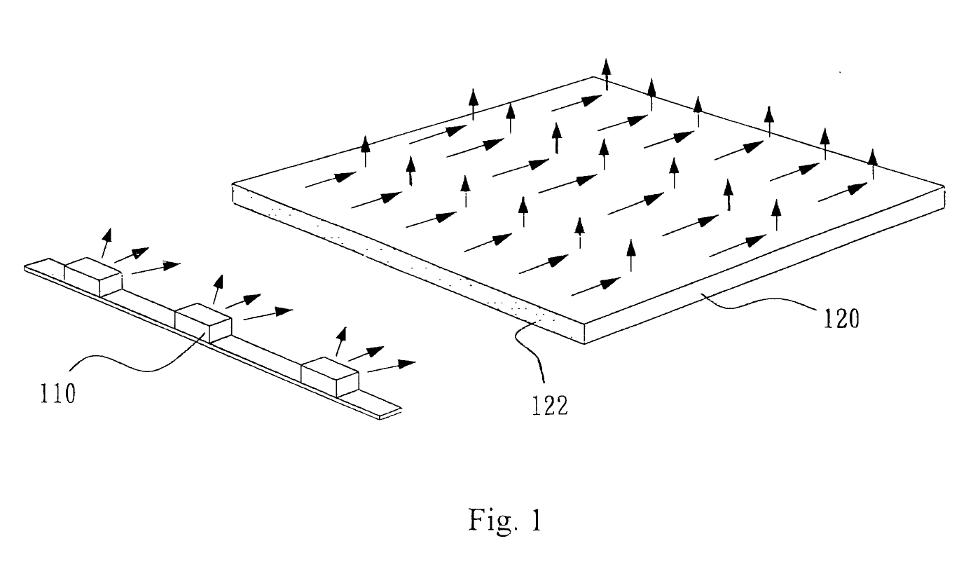

FIG. 1 is a schematic view of a preferred embodiment of the present invention.

As shown in FIG. 1, the light guide substrate 120 is shaped as a square. Three light emitting diodes 110 are on one side of the light guide substrate 120. The light guide substrate 120 has a side adjacent to the light emitting diodes 110 to receive incident light. A fluorescent composition layer 122 is coated on the side of the light guide substrate 120 on which the light is incident. The fluorescent composition layer 122 is capable of converting blue light into visible white light, which may be a Lucite product (model No. 1470X) commercially provided by Alliance Material Co. Ltd., Taiwan. In practice, the blue-light emitting diode emits a visible blue light. When the visible blue light reaches the fluorescent composition layer 122 coated on the incident side of the light guide substrate 120, blue incident light is converted into white visible light. Then, the converted light is introduced into the light guide substrate 120 and applied uniformly to the light guide substrate 120 by reflection. Accordingly, colored light sources can be used for the displays by coating a fluorescent composition capable of converting a non-white light wavelength into a white light wavelength on a side of the light guide substrate 120.

According to the other preferred embodiment of the present invention, the light guide plate and the light emitting diodes are disposed in the same manner as those of the above-described preferred embodiment, except that the light emitting diode emits an ultraviolet light which is then converted into visible white light by the fluorescent composition coated on the incident side of the light guide plate. As such, ultraviolet light from the light emitting diode is converted into visible white light by the fluorescent composition coated on the incident side of the light guide substrate, and then, the converted light is introduced into the light guide substrate to radiate onto the surface of the light guide plate uniformly. Accordingly, the present invention provides the flat panel display device such as liquid crystal displays with alternative light sources.

The light guide plate or backlight module of the present invention can use visible non-white light sources for flat panel displays. Hence, the light source of the flat panel display is no longer limited to the original color as used in common products, and expands to visible non-white light sources. Accordingly, the present invention makes the application and selection for light sources flexible and even reduces the cost for flat panel display device light sources.

Although the present invention has been explained in relation to its preferred embodiment, it is to be understood that many other possible modifications and variations can be made without departing from the spirit and scope of the invention as hereinafter claimed.

What is claimed is:

1. A light guide plate for flat panel display devices used with at least one light source, comprising:
a flat light guide substrate and at least one fluorescent composition on one side of said light guide substrate adjacent to the light source to receive incident light and convert the incident light into a white light.

2. The light guide plate as claimed in claim 1, wherein said fluorescent composition converts at least the incident light having a wavelength in the blue light region into a white light.

3. The light guide plate as claimed in claim 1, wherein said fluorescent composition converts at least the incident light having a wavelength in the ultraviolet light region into a white light.

4. The light guide plate as claimed in claim 1, wherein said light guide substrate is wedge shaped or square shaped.

5. A backlight module for flat panel display devices, comprising:
at least one light source;
a light guide plate having a fluorescent composition formed on a side adjacent to the light source; and
a reflecting plate adjacent to the light source for reflecting a light from the light source to the side of the light guide plate on which the light is incident;
wherein the fluorescent composition converts the incident light into a white light.

6. The backlight module as claimed in claim 5, wherein said fluorescent composition converts at least the incident light having a wavelength in the blue light region into a white light.

7. The backlight module as claimed in claim 5, wherein said light source is a blue-light emitting diode.

8. The backlight module as claimed in claim 5, wherein said fluorescent composition converts at least the incident light having a wavelength in the ultraviolet light region into a white light.

9. The backlight module as claimed in claim 5, wherein said light source is an ultraviolet-light emitting diode.

10. The backlight module as claimed in claim 5, wherein said light guide plate is wedge shaped or square shaped.

11. The backlight module as claimed in claim 5 further comprising an optical diffusion layer or a prism layer.

12. A flat panel display device comprising a display panel and a backlight module, said backlight module including:
at least one light source;
a light guide plate having a fluorescent composition formed on a side adjacent to the light source; and
a reflecting plate adjacent to the light source for reflecting a light from the light source to the side of the light guide plate on which the light is incident;
wherein the fluorescent composition converts the incident light into a white light.

13. The flat panel display device as claimed in claim 12, wherein said fluorescent composition converts at least the incident light having a wavelength in the blue light region into a white light.

14. The flat panel display device as claimed in claim 12, wherein said fluorescent composition converts at least the incident light having a wavelength in the ultraviolet light region into a white light.
